(19) United States
(12) Patent Application Publication
(10) Pub. No.: US 2002/0016967 A1
(43) Pub. Date: Feb. 7, 2002

(54) In-waiting room health-care information service

(76) Inventor: John R. Carlile, Springfield, MO (US)

Correspondence Address: Jonathan A. Bay, Attorney at Law, Suite 314, 333 Park Central East, Springfield, MO, 65806, US

(21) Appl. No.: 09/802,742

(22) Filed: Mar. 8, 2001

Related U.S. Application Data
(60) Provisional application No. 60/229,178, filed on Aug. 29, 2000.
(60) Provisional application No. 60/224,262, filed on Aug. 10, 2000.
(60) Provisional application No. 60/187,952, filed on Mar. 9, 2000.

(51) Int. Cl. H04N 7/18; H04N 7/173; G06F 3/00; H04N 5/445; G06F 13/00

(52) U.S. Cl. 725/78; 725/109; 725/37

(57) ABSTRACT

A method of in-waiting room health-care information services comprises providing a physician's waiting room with an in-waiting room video display unit. Video programming from a remote database of health-care information is continually played over the in-waiting room video display unit. Interested waiting-room parties can at least glance over the programming. Later on, such interested waiting-room parties can independently access the remote database over the Internet for deeper online research. Hence the in-waiting room display unit showcases the health-care information video programming to attract interested waiting-room parties into deeper online research so that patients might learn more clearly how to be involved in and comply with their prescribed regimen of treatment. The in-waiting room play of the programming serves to strengthen the patient-physician relationship by exemplifying the physician's interest in success and endeavor to be at the forefront of recent developments.

### CROSS-REFERENCE TO PROVISIONAL APPLICATION(S)

This application claims the benefit of U.S. Provisional Application No. 60/229,178, filed Aug. 29, 2000; U.S. Provisional Application No. 60/224,262, filed Aug. 10, 2000; and, U.S. Provisional Application No. 60/187,952, filed Mar. 9, 2000.

### BACKGROUND OF THE INVENTION

1. Field of the Invention

The invention relates to a method and system for providing in-waiting and/or—exam room informational and/or amusement services for patients of physicians and like professionals of the health care and medical field. To date, the time a patient spends waiting before or between actual visitation with a medical and/or health care professional(s) is under-utilized, if utilized at all. The invention arguably remedies that.

2. Prior Art

FIG. 1 is a block diagram view of a physician office having a waiting room in accordance with the prior art. One block represents the treating physician and another represents a given patient. Several other block represent various parties who might at different times provide the physician with information concerning recent developments in the diagnosis of disease or disorder as well as new medications, procedures or treatments and the like.

These other parties include medical journals and literature covering the topics of current interest for the medically-trained community. Continuing education resources overlap some of the same coverage but may concentrate on more practical aspects thereof. Pharmaceutical sales reps are constantly calling on physicians to sell them on writing scripts on new medications. To a lesser extent, vendors of equipment used in new procedures or treatments might likewise contact physicians with information on new developments or the like. Health insurance companies are a storehouse of all kinds of information impacting the choice of treatment options for a particular patient. Especially in cases where the choice of one treatment option over another is swayed by the fact that such particular patient's insurance substantially covers the one treatment but substantially not the other.

Therefore, as FIG. 1 shows, the physician is in continuous interaction with various parties who provide the physician with resources of information to remain at the fore of the practice of medicine, to provide patients with high quality health care. With continued reference to FIG. 1, the latecomer to this scene is the patient. All the interaction by the parties depicted over the patient in FIG. 1 has transpired for the benefit of that physician providing high quality health care to that particular patient on the occasion of that patient's relationship with that physician. As said, the patient is the latecomer on the scene, and much has happened.

Experienced physicians know that much of what they tell their patients is not translated in appropriate actions by the patient. Patients do not always complete a prescribed course of medication correctly, and continue to use it as long as needed for sustained results. Patients may not avoid certain activities, other medications or herbal remedies which detract from the effectiveness of the prescribed regimen of treatment. And so experience teaches that the best results are gotten by an informed patient who takes interest in understanding their disease or disorder, their treatment options, and a much clearer notion of how they can work with their physician in treating their condition.

Nowadays there is a mass of pertinent information for patients to access and learn about their diseases and treatment options. Some sources are authoritative, others are spurious. Regrettably, researching among the authoritative sources is an intimidating task. So the typical consumer typically skips over the authoritative sources in favor of researching among the commercially appealing sources as, for example, the much-hyped fad diets. Consequently, those patients who do make independent effort on their own time to research the information they should often get sidetracked into questionable materials. Indeed the questionable materials are more attractive. They oversell their benefits and downplay or omit mention of their limitations. More authoritative materials are not likely to claim “magic bullet” success against targeted condition(s) and surely won't omit mention of limitations or side effects. In contrast, authoritative materials are likely to provide a balanced assessment of probabilities of effectiveness against probabilities of limitations or other effects. It is often times not best-selling material. It is sober and not hype-ridden with hope where there is little hope. Yet a patient's best chances of being restored to the best possible function or at least ameliorating the bad consequences of disease or disorder are best gotten by following the authoritative regimen of treatment.

What is needed is an improvement which directs patients to researching among authoritative health-care materials on their diseases or disorders in order to improve their understanding and chances for restoration to full function or at least amelioration of the bad consequences.

### SUMMARY OF THE INVENTION

It is an object of the invention to provide an in-waiting room health-care information service so that patients are afforded an opportunity to improve their understanding of their disease and the treatment options available to them in the format of video programming which gains impact be being seen in the milieu of the physician's waiting room.

It is an alternate object of the invention that the above in-waiting room health-care information service be implemented to service a diversity of physician offices with a diversity of available heath-care information program options.

It is an additional object of the invention that the health-care information programming seen in any participating physician's waiting room is alternatively provided for utilization over the Internet from a master database so that interested parties can review and reflect on the programming at times and places of their own choosing, and thereby be optimally involved in and compliant to their prescribed regimen of treatment in order to gain optimal restoration of function from their condition in optimal recovery time, or at least optimally ameliorate the bad consequences of the disease or injury.

It is another object of the invention that the in-waiting room health-care information service promote high-level patient and doctor discourse on the technical subjects of medications, procedures and corresponding matters of treatment.

These and other aspects and objects are provided according to the invention by a method of in-waiting room health-care information services comprises providing a physician's waiting room with an in-waiting room video display unit. Video programming from a remote database of health-care information is continually played over the in-waiting room video display unit. Interested waiting-room parties can at least glance over the programming. Later on, such interested waiting-room parties can independently access the remote database over the Internet for deeper online research. Hence the in-waiting room display unit showcases the health-care information video programming to attract interested waiting-room parties into deeper online research so that patients might learn more clearly how to be involved in and comply with their prescribed regimen of treatment. The in-waiting room play of the programming serves to strengthen the patient-physician relationship by exemplifying the physician's interest in success and endeavor to be at the forefront of recent developments.

Additional aspects and objects of the invention will be apparent in connection with the discussion further below of preferred embodiments and examples.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the appended claims. In the drawings,

FIG. 1 is a block diagram view of an office of a physician who provides a waiting room in accordance with the prior art for patients, and showing various other parties who provide the physician with information concerning recent developments in the diagnosis of disease or disorder as well as new medications, procedures or treatments and the like;

FIG. 2 is a block diagram view comparable to FIG. 1 excepting showing inclusion of an in-waiting room health-care information service in accordance with the invention, including back office and Internet use options;

FIG. 3 is a block diagram view comparable to FIG. 2 excepting isolating on aspects of the use options of the in-waiting room health-care information service in accordance with the invention;

FIG. 4 is a block diagram view showing aspects of customization options for the in-waiting room health-care information service in accordance with the invention;

FIG. 5 is a block diagram view showing aspects of Internet use options for the in-waiting room health-care information service in accordance with the invention;

FIG. 6 is a block diagram view showing aspects of in-waiting room use options of the in-waiting room health-care information service in accordance with the invention; and,

FIG. 7 is a block diagram view showing aspects of the exchange of expertise among various parties to the in-waiting room health-care information service in accordance with the invention.

### DETAILED DESCRIPTION OF THE PREFERRED EMBODIMENTS

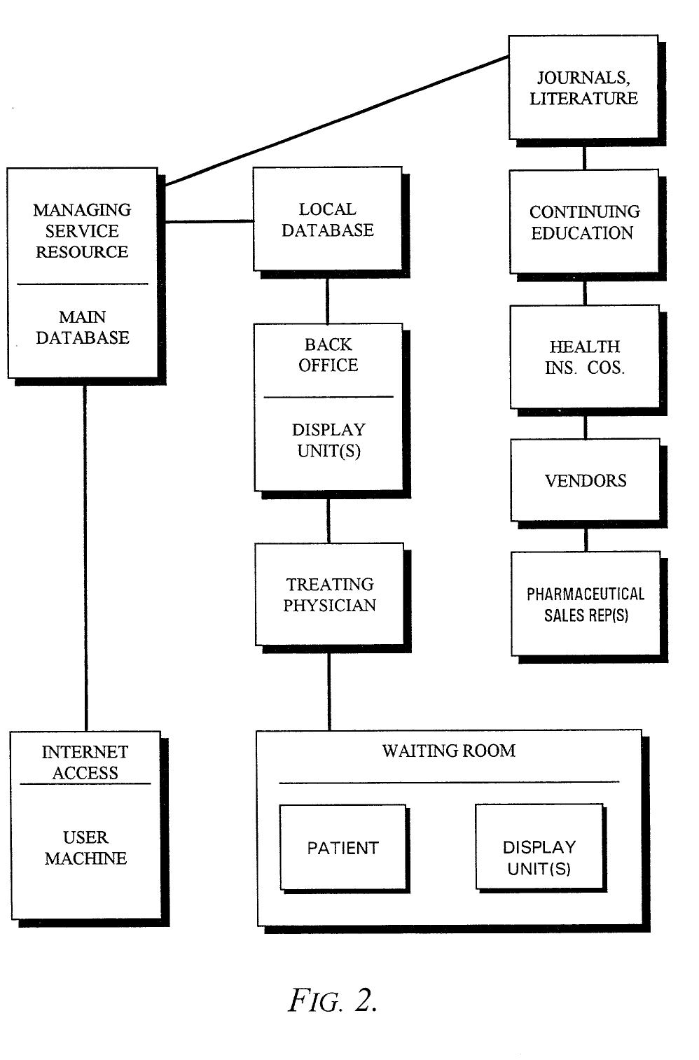

FIG. 2 shows an in-waiting room health-care information service in accordance with the invention. A physician's office comprises among other things the waiting room and a back office. The back office may have all manner of other areas including perhaps one or more exam rooms and then other kinds of rooms as for patient education, rehabilitation or the like. The patient waiting room is provided with one or more inventive in-waiting room video display units. Aspects of these in-waiting room display units will be described more particularly below. The exam rooms as well as patient education rooms may be equipped with comparable display unit for reasons explained more particularly below. Indeed, FIG. 2 does illustrate back office display units.

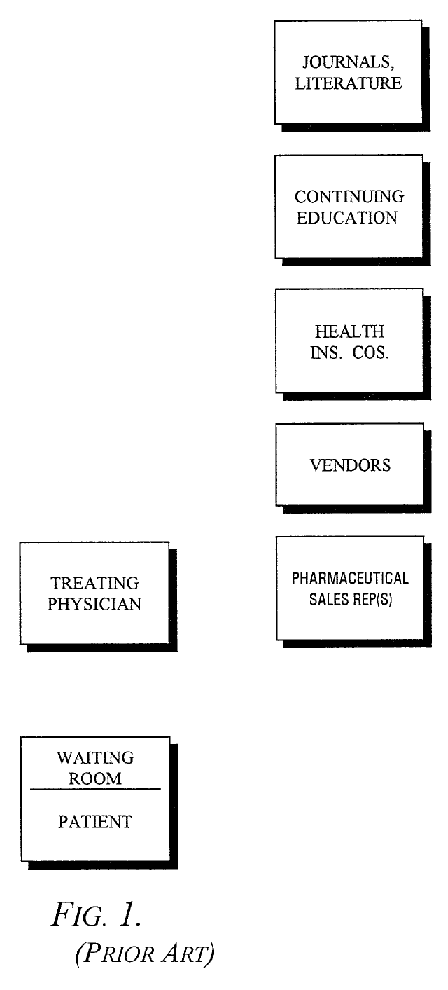

The physician office includes local storage devices for the video programming. The storage devices may comprise the distributed hard drives of each attached computer to a video display unit (in cases if there is one). Or else the local storage handling might be served by a local server device as an Intranet server or the like. FIG. 2 like FIG. 1 includes a column of parties anchored by the pharmaceutical sales reps. This column of parties represents candidate parties who might provide content for the programming or else even sponsor the production of programming. The programming in some segments will feature subjects as new medications, new procedures, equipment and supplies, spots on state of the art research, and perhaps health insurance coverage as well as Medicare/Medicaid matters too. Hence the parties in this column may get directly involved in programming production and may have ready-to-go materials ready for use. These materials might even be treated as paid advertising.

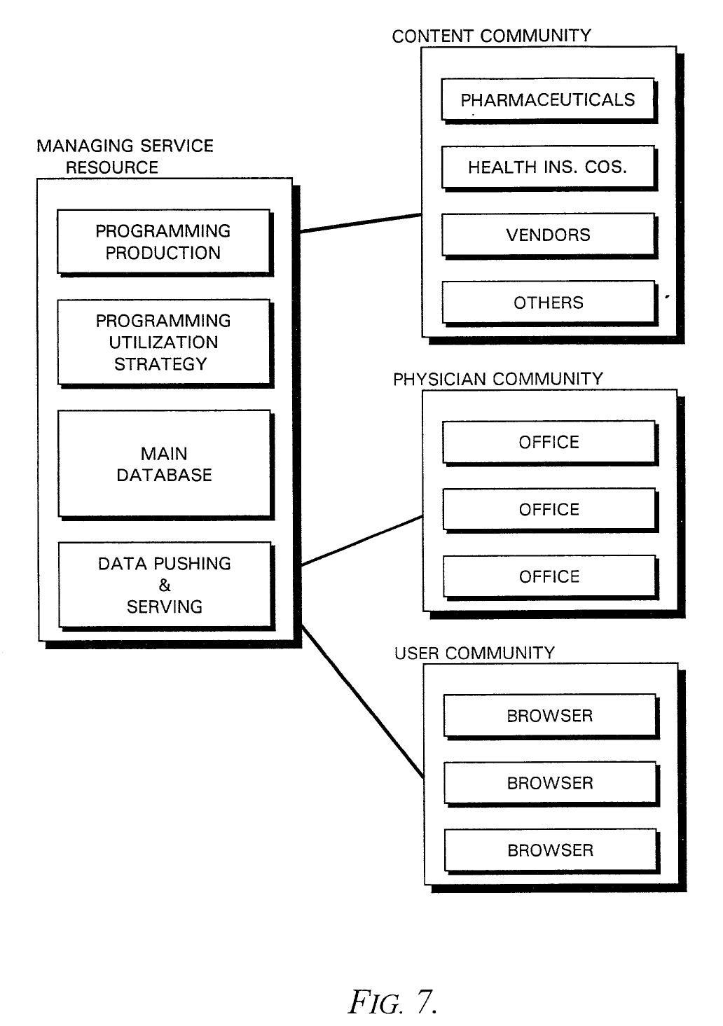

To govern the tone of the programming, the invention includes a managing service resource to balance the various interests involved here including the patient community, the physician community, and then the “content” community as it is labeled in FIG. 7, and as shown in the right side column in FIGS. 1 and 2. The programming is to be relevant to the patient's interests, professionally produced, and medically authoritative. Sometimes a doctor's need to prescribe an effective but affordable remedy will conflict with an advertiser's need to sell products by the patients request for a drug seen on the programming. A potential conflict exists because the doctor will not always believe that the best treatment for the individual patient is the product which the patient, prompted by the programming in the waiting room, has asked for. The physician may believe an alternative treatment is more desirable, either because of among other things its medical efficacy or lower cost. Balancing that potential problem is the potential for better results coming from better-informed patients using the prescribed course of treatment correctly, and continuing its use as long as needed for sustained results. A mission statement for the managing service resource might be, that the better informed the patient, the more likely they will be compliant with the prescribed treatment.

The managing service resource operates on a set of standards designed to be acceptable to the broader physician community. The physicians after all are the parties who agree to introduction of this programming into their waiting rooms. The programming content falls under the strict scrutiny of numerous agencies including the Food and Drug Administration, the Federal Trade Commission, the American Medical Association and the licensing agencies of the several states. Other third-party organizations have previously drafted applicable standards including for example the American Accreditation HealthCare Commission's (URAC's) “Health Web Site Standards,” as published at http://www.urac.org/010226WebPublicComment.htm. The managing resource service may adopt these standards voluntarily as minimums with slight modifications to reflect the business focus of the inventive enterprise of the in waiting room health-care information service in accordance with the invention as a whole.

To return to FIG. 2, it shows the managing service resource presiding over among many other things a main database, which may be distributed though shown in the drawings as a single block within the domain of the managing service resource. However configured, the main database is likely remote from the local databases needed by the physician offices. Communication links between the main and local databases will allow some data transmission. However, the video data files are likely to be so large such that the preferred communications medium of the Internet might not handle the volume of transmission to make the system practicable. Therefore, some video data might have to be physically carried from the main database to local databases by means of portable media as DVD's.

FIG. 2 shows an in-waiting room patient getting exposed to the programming playing on the in-waiting room display unit. Preferably the programming comprises audio-visual material in the style of television news-reporting or infomercial. Alternatively the video data might be configured to handle a sequence of still pictures like a narrated slide show. Regardless, the programming is chosen with the target audience in mind, namely, patients or their guests in a physician waiting room preceding a visit with the physician. The programming is targeted based on the defined interests of the in-waiting room parties. These defined interests can be determined in multiple ways. The doctors can be offered a menu of recommended programming for their area of practice. Surveys can be designed and administered to the in-waiting room parties to more accurately ascertain their interests. Also, since the in-waiting room patients are to be directed to independent research on the managing service resource's website, their requests there will afford analysis to see where their interests lie. What to provide in the way of programming will be more particularly discussed below.

Briefly, the in-waiting room health-care information video programming ought to encompass at least matters of the diagnosis of disease or disorder as well as matters of medications, procedures or other treatments. The in-waiting room video display unit provides interested waiting-room parties the opportunity to at least glance over the programming. If they are sufficiently interested, such interested waiting-room parties are certainly welcomed to access to the material on the main database by the Internet for deeper online research at that time. Optimally, the in-waiting room showcasing of the health-care information video programming attracts such interested waiting-room parties into deeper research on the main database in order that patients thereby learn more clearly how to be involved in and more completely comply with their prescribed regimen of treatment. The in-waiting room play of the programming also serves to strengthen the patient-physician relationship by exemplifying the physician's interest in success and endeavor to be at the forefront of recent developments.

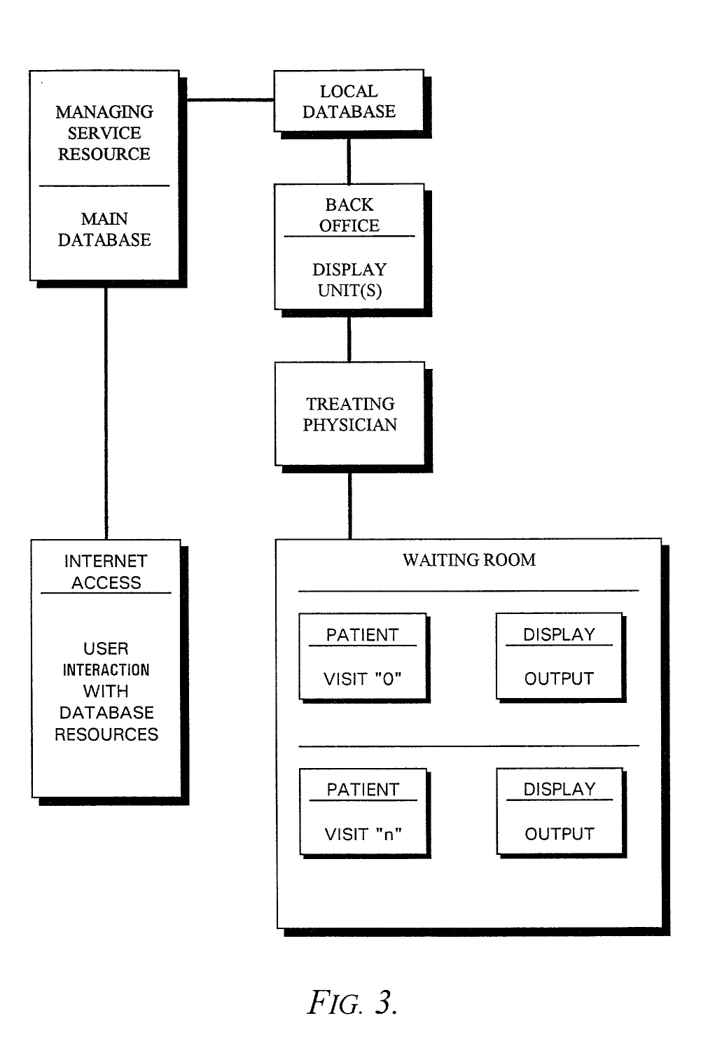

FIG. 3 shows the differing interests of a given patient depending on if it's the patient's original visit to the office for that disease or disorder, or else a succeeding visit. For an original visit, the programming should accomplish a couple of objectives. The programming should get the patient's attention. It should get the patient thinking about matters such as the origin or etiology of disease or disorder. That is, the patient is immediately next going to see the physician who will base a prescribed treatment upon the examination. The patient can be helpful by providing all the pertinent information and not omitting something helpful. However, the programming should not provide suggestions of symptoms. The programming should provide instructions in the necessity for providing accurate history of the disease or disorder. The programming should sell the patient on the virtue of learning more about disease diagnosis and treatment so that if the patient is informed he or she can access these same video programs (plus more) at home then the patient might trouble him or herself to do so.

At the time the patient is admitted to the back office, the back office display units allow these further use options. A physician or the staff might review with a patient some matter available on the programming which teaches a particular procedure. For a simple example, consider perhaps how to give a small child a pill. This can be done in the exam room itself or in an instruction room. The doctor might even “prescribe” that the patient go home and watch certain programming on their own time. The prescription can be handed out by giving the patient the URL address as well as the specific page information to get to the programming. The prescription might alternatively take the format of a link sent to the patient's e-mail. In sum, physicians and their staff may utilize the educational potential of the resources to maximize efficient patient flow through the office. Patient education for common problems encountered can be facilitated by the various resources, freeing office staff and physicians to interact more with patients. Given the limited time physicians have, the programming gives them a delegation option. That is, instead of delegating nurses to spend more time educating the patient, the programming can be utilized in this role by means of “prescription.” The patient's online use allows reflection and reinforcement of instructions gotten in office visit. And the programming is consistent. People may omit some things on telling and re-telling a given set of instructions, or embellish less important matters. The programming is consistent and is produced and edited for completeness and effectiveness in conveying the information.

Next, turning to the matter of a patient's succeeding visit to the office, the programming provides material interesting to more experienced patients. For example, a particular regimen of treatment actually involves much more than diagnosis and medication. The programming might induce the patient to learn that medication, diet and exercise together comprise a regimen of treatment. The goal is to correctly diagnose and treat diseases and restore patients to full function, or at least ameliorate the bad consequences of disease and injury by the best means. Asthma is a condition among others that requires lifestyle changes as well as changes in house- and/or pet-keeping. The programming ought to provide news for patients on recent developments in order to promote dialog with the physician if the recent developments pertain to that patient. Overall, the programming should improve a patient's understanding of the applicable disease or disorder including origin to help provide data to the physician during exam interviews and so provide better material to the physician for diagnosis and/or explanation of the reason behind treatment options, as well as the patient's understanding of treatment options available to them and a much clearer notion of how they can work with their physician in treating their condition.

Whereas FIG. 3 shows the patient of an original visit watching one display as the patient on a succeeding visit watching another display, there may actually be only one display. The programming carries a variety of segments pertinent to a variety of patients.

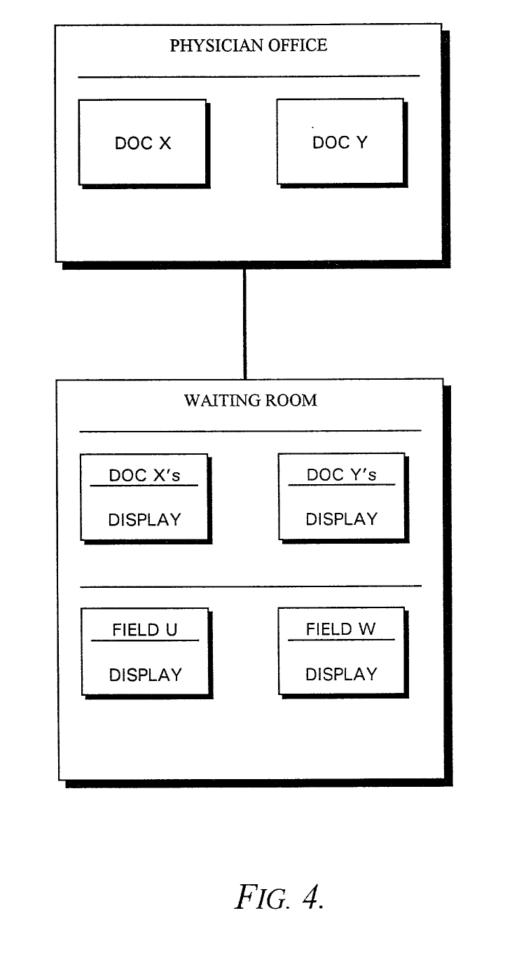

FIG. 4 very distinctly shows the utilization of at least plural displays. In FIG. 4, the representative physician office is a joint practice of at least Doc X and Doc Y. Each of Doc X and Doc Y prefer their patients see a customized set of programming that differs from the preferences of the other of Doc Y or Doc X. In this case, each of Doc X and Doc Y can be accommodated with separate in-waiting room display units showing that Doc's preferred programming.

Alternatively, FIG. 4 shows that one in-waiting room display unit may be dedicated to programming of a specific subject matter as another (other) in-waiting room display unit(s) are dedicated to other subject matter. For example, one in-waiting room display unit might play programming pertaining to asthma as another plays programming dedicated to allergies and so on. The customization of the programming can be accomplished for about any practice specialty and/or targeted disease, disorder or by about any set of preferences as desired.

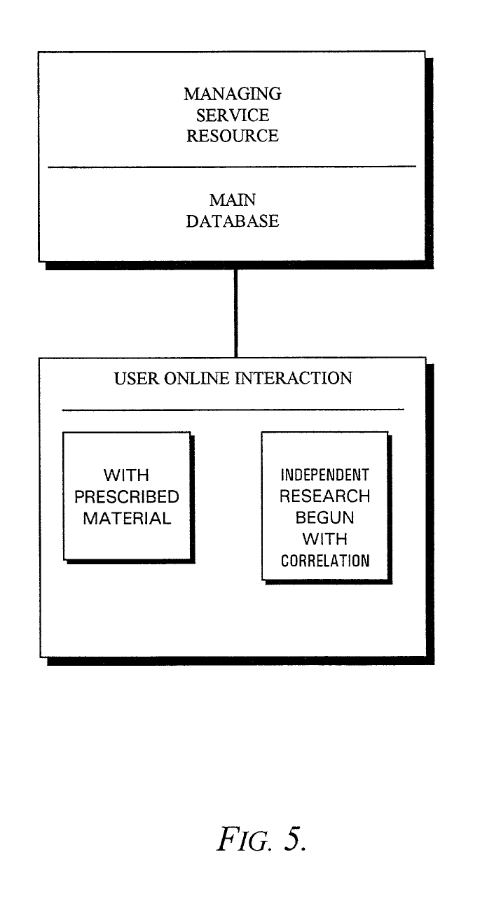

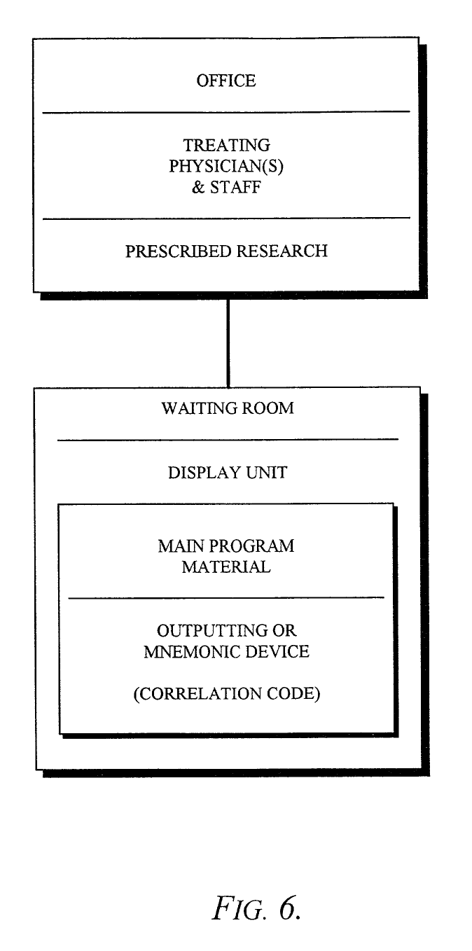

FIGS. 5 and 6 together show other use options of the in-waiting room health-care information service in accordance with the invention. FIG. 5 shows a user interacting independently with the main database material as from home or the like by an Internet connection. Presumptively, the user was originally introduced to the programming by some earlier in-waiting room contact with the programming. From that experience, the user was led to conduct independent research on the user's own time.

FIG. 5 shows one instance where the user is requesting material actually prescribed to that user either by the treating physician or else the staff. FIG. 6 shows an instance of the patient being prescribed material in the back office. As previously mentioned, the URL address and pertinent sub-domain and/or web page address information might be printed out for the patient. That way the patient can type in the information at home. Alternatively, the physician office might have e-mailed the link to the particular material that is prescribed. From that point of origin in the database, a curious user is well-advised to research among associated materials or allied branches to other online resources for pertinent material.

FIGS. 5 and 6 show another inventive aspect of the in-waiting room health-care information service in accordance with the invention. That is, as FIG. 6 shows, the in-waiting room display unit has a screen displaying the programming. A small box on the screen might print a scrolling mnemonic. For example, in a pediatrician's office, one temporary mnemonic might be “mother goose.” The “mother goose” mnemonic might be shown at times when the programming is teaching how to give a small child a pill. The script/narration might reinforce the mnemonic by stating it at intervals. The physician office can leave literature in the waiting room which prominently prints the health-care information service's website address. As FIG. 5 shows, when the user gets home, the user can call up approximately the same program in a two step procedure. The user can first request service of the health-care information service's website by entering in the URL address. The health-care information service's home page can offer a search option by mnemonic (or whatever other correlation code). Entering in the mnemonic “mother goose” ought to serve the user essentially the same programming the user saw in the treating physician's waiting room. From that point of origin the user is well-advised to research among related topics as the website offers.

The in-waiting room display unit might optionally include a tandem of say a 25″ television set screen and then also say a 15″ touch screen monitor. That way, if the waiting room traffic is not too busy, in-waiting room parties might be afforded the opportunity to personally interact with the programming right there on-site. Indeed the in-waiting room display unit might have an attached printer allowing the in-waiting room party to print out the script for the programming or else illustrations and the like. However, the other option might be to just provide in-waiting room parties with correlation codes and URL addresses so that the in-waiting room parties can request service of substantially the same programming from the managing service resource's main website. At home the user can print the script and illustrations as desired.

FIG. 7 allows an overview of how the in-waiting room health-care information service in accordance with the invention may be utilized by the various parties. The managing service resource serves the parties as a whole. It facilitates the exchange of expertise among various parties. These parties comprise a distributed physician community, a distributed user community, and a distributed content community. The in-waiting room health-care information service broadly facilitates the interaction among patient, physician and content parties by multiple opportunities for the parties to hold at least two-way dialog on a given topic, and then maybe move onto other topics. Indeed, in some instances the dialog is a virtual three-way dialog. Consider an in-waiting room infomercial on a given medicine. It is like having a virtual pharmaceutical sales rep in a physician's office virtually concurrently with the personal meeting between the physician and patient. The programming plants the suggestion in the patient's mind to talk with the physician about adopting the medications or procedures or treatments shown by the programming. Only minutes pass between a patient seeing the programming and the visit with the doctor.

The content community might include sponsors of, partners to or simply advertisers on the service. For example, nowadays pharmaceutical companies expend large resources in advertising their medications. If they advertise on television, their target audience is thinly distributed and not really very concentrated. Although most pharmaceutical products and medical procedures have a limited target market at any given time, over enough time almost everyone may need the products and procedures which alleviate symptoms and improve recovery time from the pertinent disease or injury. In contrast to a thinly distributed target audience among a television broadcast's viewership, a waiting room full of say allergy and asthma patients affords an antihistamine advertisement the best possible target audience the advertiser most desires to reach, and at the best-possible time:—immediately before a visit with an allergist. The in-waiting room patient can ask his or her doctor during the exam about the advertised medicine. The doctor still decides what medications to prescribe in consideration of the best interests of the patient. But if that decision will allow a prescription of that advertised medicine, then the advertisement was effective and served well all three parties of advertiser, patient and physician alike.

Health insurance companies might allow insured parties to research the extent of their coverage on particular matters. The managing service resource might provide a standardized diagnosis code or treatment code for a given disease, disorder or combination of more than one disease and/or disorder. The health insurance company might provide individual insured parties with an identification code. Entering the two codes together might provide analysis of what one particular insured party's insurance coverage covers in specific relation to the given diagnosis and/or treatment code.

Vendors other than pharmaceutical companies might include vendors of home- or specialty health-care products, equipment or supplies. The residual category of “others” admits all manner of other parties. Geriatricians might find that owners of retirement communities are willing to advertise on their in-waiting room programming segments. Just as eager might be cataract surgery specialists. Hence, physicians of a complementary specialty might desire to advertise in another specialty's waiting room.

The managing service resource ties the whole enterprise together. It is ultimately responsible for programming approval and/or production. It devises programming utilization strategy. It hosts or contracts for the hosting of the main website and database, even if the data is actually distributed. The managing service resource also manages over programming distribution (eg., “data pushing”) to the distributed physician offices as well as data serving to the user community who contact it through the Internet.

Given the foregoing, the in-waiting room health-care information service provides various advantages as readily apparent to those having routine skill in the art including without limitation some of the following. Some of the inventive service's main purposes include improving and facilitating authoritative patient education with the aim of improving patient compliance. It serves to strengthen the relationship between patients and physicians by being an example of the physician's interest in success and endeavor to be at the forefront of recent developments. The in-waiting room health-care information service reaches a targeted audience that the content community most desires to reach and at the best-possible time (eg., immediately preceding a doctor appointment). The in-waiting room information service can provide feedback to the physician and content community on the effect or effectiveness of the programming or promotions.

The programming derives impact from being seen in milieu of doctor's office. It provokes patient-doctor dialog on topics seen in the waiting room just moments before:—eg., a medication, a procedure and so on. The inventive in-waiting room health-care information programming is reinforced in multiples:—eg., by back office utilization, or interaction therewith over the Internet and the like for further research.

And one of the last advantages addressed here in connection with the inventive in-waiting room health-care information service is by no means the least. It concerns physician education, or alternatively, a manner of virtual continuing education for doctors. The programming is on the Internet and they can choose to learn when they have time.

The physician continuing education aspects involve some of the following matters. When a new development start to gain some steam, a physician is originally challenged to rate the new development against previously used medicines or procedures. In regards of new medicines, physicians are often served by pharmaceutical sales reps. The pharmaceutical sales reps have often filled a quasi-continuing education role by hand-carrying and personally summarizing industry-sponsored research.

However, the existence of the inventive in-waiting room health-care information service applies some pressure on physicians to be at the front of the wave with new developments. At the original introduction of a new medicine, a pharmaceutical sales rep won't merely be saying “allow me to introduce BrandNew,” but will be empowered to say “allow me to introduce this video spot on BrandNew that your patients are going to see in your own lobby immediately before their visit with you. Now may I help you be more informed?” Again, the physician is likely to feel some pressure to get up to speed on BrandNew especially in contemplation of an onslaught of patient inquires. The early posting of the information allows the doctor to get informed early.

This is not to suggest that doctors have a learning deficit to make up when a new development breaks. Doctors have to be aware of a lot of information. Pharmaceutical sales rep are educated by their companies to provide doctors with a personal seminar course on a specific topic, yet it remains the doctor's responsibility to mentally file and cross-file the information away for use another day. The patient is largely oblivious and a latecomer to all this high-level exchange of technical information. While in some instances patients do need not much information just very simplistic instructions, in other instances patients are best served if educated, involved, and brought into this very high-level technical discourse and debate on the merits of the new developments. Hence the inventive in-waiting room health-care information service facilitates a three-way exchange on new developments including doctors getting authoritative information early, pharmaceutical sales reps getting reinforcement from the service's programming, and patients just plain getting access to it as an original matter, and interpreted into everyday language.

In the foregoing description the reference to physician or doctor has been used for convenience only and does not limit the invention from utilization by health-care providers in the more general sense including without limitation optometrists, dentists, physical/occupational therapists and the like, or nutritionists and chiropractors and so on. Also, the inventive in-waiting room health-care information service can be implemented in the offices of general practitioners and specialists alike, and from large medical service firms to joint practitioners to down as far as even sole practitioners.

A few remarks are worth making on the proto-type efforts for the in-waiting room display units and supporting hardware. In general, the in-waiting room display units might comprise the following elements. They ought to be secure from tampering while still capable of being programmed remotely from the central web site. Each in-waiting room display unit will include custom-built cabinetry that will hold a computer and a 25″ television set, and optionally a laser printer. The computer will have a 15″ touch screen monitor which allows the patient to request a information from data stored at the central database. The requested materials might be printed out on the laser printer.

Each in-waiting room display unit ought to run on Microsoft Windows 2000 software, as well as software to allow it to connect with the central site. Because speed is important, much of the software needed to display programming must be on each local computer.

Display programming will be updated at 90-day intervals. At first, programming will be stored on DVD disks created at the central site and distributed by Field Representatives to each local database serving an in-waiting room display unit. Alternatively, each in-waiting room display unit will play its programming from its own DVD. The central site might control when the sets will be turned on and off and what programs will be displayed, using software at the central site and transmitting commands to each in-waiting room display unit. In turn, at five minute intervals throughout the day, each in-waiting room display unit might send status information to the central site confirming that the in-waiting room display unit equipment is running, and telling the central site what programming is playing and in connection with what displayed mnemonic or correlation code.

Because each doctor's office has unique scheduling for office hours and unique needs for controls such as volume, a database must be built that stores this information so the in-waiting room display unit can retrieve stored values and report to the central site as needed.

In general, managing resource will build a closed TCP/IP based Intranet/Ethernet network with each Intranet in-waiting room display unit connected by one of the following:

DSL/ADSL

Frame Relay

ISDN

The type of network communications used by each in-waiting room display unit workstation will be dictated by what communications capability is available at that location. The preferred method is DSL-enabled in-waiting room display units that are equipped with DSL or ADSL connections and can receive programming directly from the central site. Alternatively, the in-waiting room display unit might depend on DVD disks for updated programming.

In addition to the in-waiting room display units, the network will have the following components:

Windows NT Primary Domain Controller

Windows NT File Server and Backup Domain Controller

Windows NT Database Server

Local Windows NT Support Workstations

There are numerous processes that will need to be performed at the central office. These processes vary from performing site surveys, assembling and shipping in-waiting room display units, monitoring/maintaining the network to sales and contracts. To support the in-waiting room display units in the field, the two primary processes will be:

Updating Databases

Distributing Video Updates

In matters of distributing video programming updates, at first, video program updates will be distributed manually on a DVD disk. DVD disks are cost effective and have the capacity to hold the two to three gigabytes of data that make up an hour long of programming material. In general, a DVD disk will be made and then sent to maintenance personnel that will visit the site. The video data (.vob data files) will be placed in the DVD drive on each in-waiting room display unit and copied down to a designated folder on the in-waiting room display unit's hard drive. As the network infrastructure becomes available, video updates will be distributed over network channels to those in-waiting room display unit's that have DSL connections or the like.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

I claim:

1. A method of in-waiting room health-care information services, comprising the steps of:
providing a physician's office with a patient waiting room;
providing the waiting room with an in-waiting room video display unit;
providing a remote database with health-care information video programming encompassing at least matters of the diagnosis of disease or disorder or, as well, matters of medications, procedures or other treatments;
continually playing a sub-set of the programming over the in-waiting room video display unit to afford interested waiting-room parties the opportunity to view the programming; and
providing such interested waiting-room parties with Internet access to the remote database for deeper online research therein whereby the in-waiting room showcasing of the health-care information video programming attracts such interested waiting-room parties into deeper research therein in order that patients thereby learn more clearly how to be involved in and more completely comply with their prescribed regimen of treatment.

2. The method of claim 1 wherein the video programming comprises full audio-visual formats or sequenced still pictures in the style of a narrated slide show.

3. The method of claim 1 further comprising providing an intermediate database for the sub-set of programming.

4. The method of claim 3 wherein the intermediate database comprises any of a DVD device or a local hard drive of a computer attached to the in-waiting room video display unit or a LAN device or an Intranet server.

5. The method of claim 1 wherein the in-waiting room video display unit is linked to the remote database by the Internet for transmission of video programming and control data.

6. The method of claim 1 further comprising providing the physician's offices at least one back office provided with at least one back office video display unit for playing selections of the health-care video programming chosen by a physician or staff for the viewing of a patient party for instruction or education purposes.

7. The method of claim 1 further comprising a physician or staff of the office providing a patient part with a virtual prescription to review given selections of the remote database's health-care information video programming independently from the physician's office for instruction or education purposes, whereby the virtual prescription gains impact by being provided by the same source providing the in-waiting room programming available in the milieu of the physician's waiting room, and the later online play of the virtual prescription programming allows reflection and reinforces instructions gotten in the office.

8. The method of claim 1 wherein the sub-set of programming playing over the in-waiting room video display unit is correlated with an index code, wherein interested in-waiting room parties are provided with well-published access to then-current given index code such that such interested in-waiting room parties can at another time and place request service over the Internet from the remote database for substantially the same programming seen in the milieu of the waiting room by reference to the given index code.

9. A method of in-waiting room health-care information services, comprising the steps of:
providing a diversity of distributed physician offices, each having at least one patient waiting room;
providing the diverse waiting rooms with at least one in-waiting room video display unit;
providing a remote database of health-care information video programming encompassing at least matters of the diagnosis of disease or disorder or, as well, matters of medications, procedures or other treatments;
continually playing diverse sub-sets of the programming over the in-waiting room video display units in the diverse waiting rooms to afford interested waiting-room parties the opportunity to view the programming; and
providing such interested waiting-room parties with Internet access to the remote database for deeper online research therein whereby the in-waiting room showcasing of the health-care information video programming attracts such interested waiting-room parties into deeper research in the remote database in order that patients thereby learn more clearly how to be involved in and more completely comply with their prescribed regimen of treatment.

10. The method of claim 9 wherein the video programming comprises full audio-visual formats or sequenced still pictures in the style of a narrated slide show.

11. The method of claim 9 further comprising providing a plurality of distributed intermediate databases for serving one or more of the in-waiting room video display units with health-care information video programming.

12. The method of claim 11 wherein the intermediate database comprises any of a DVD device or a local hard drive of a computer attached to the in-waiting room video display unit or a LAN device or an Intranet server.

13. The method of claim 9 wherein the in-waiting room video display units are linked to the remote database by the Internet for transmission of video programming and control data.

14. The method of claim 9 further comprising providing at least some of the physician's offices with at least one back office provided with at least one back office video display unit for playing selections of the health-care video programming chosen by a physician or staff for the viewing of a patient party for instruction or education purposes.

15. The method of claim 9 further comprising a physician or staff of the office providing a patient part with a virtual prescription to review given selections of the remote database's health-care information video programming independently from the physician's office for instruction or education purposes, whereby the virtual prescription gains impact by being provided by the same source providing the in-waiting room programming available in the milieu of the physician's waiting room, and the later online play of the virtual prescription programming allows reflection and reinforces instructions gotten in the office.

16. The method of claim 9 wherein each of the diverse sub-sets of programming playing over the in-waiting room video display units in the diverse waiting rooms is correlated with an index code, wherein interested in-waiting room parties are provided with well-published access to a then-current given index code such that such interested in-waiting room parties can at another time and place request service over the Internet from the remote database for substantially the same programming seen in the milieu of the waiting room by reference to the given index code.

17. A method of in-waiting room health-care information services, comprising the steps of:
providing a diversity of distributed physician offices, each having at least one patient waiting room;
providing the diverse waiting rooms with at least one in-waiting room video display unit;
providing a remote database of health-care information video programming encompassing at least matters of the diagnosis of disease or disorder or, as well, matters of medications, procedures or other treatments;
continually playing diverse sub-sets of the programming over the in-waiting room video display units in the diverse waiting rooms to afford interested waiting-room parties the opportunity to view the programming and publishing a given mnemonic in connection with a given piece of programming; and
providing such interested waiting-room parties with Internet access to the remote database so that at another time and place such interested waiting-room parties can request service over the Internet from the remote database for replay of programming corresponding to the given piece of programming seen in the milieu of the waiting room by reference to the given mnemonic.

18. The method of claim 17 wherein the given mnemonic is published be any of graphic printing or stated during the script.

19. The method of claim 17 further comprising providing at least some of the physician's offices with at least one back office provided with at least one back office video display unit for playing selections of the health-care video programming chosen by a physician or staff for the viewing of a patient party for instruction or education purposes.

20. The method of claim 19 further comprising a physician or staff of the office providing a patient part with a virtual prescription to review given selections of the remote database's health-care information video programming independently from the physician's office for instruction or education purposes, whereby the virtual prescription gains impact by being provided by the same source providing the in-waiting room or back office programming available in the milieu of the physician's office, and the later online review of the virtual prescription programming allows reflection and reinforces instructions gotten in the office.
